(19) United States
(12) Patent Application Publication
(10) Pub. No.: US 2017/0321664 A1
(43) Pub. Date: Nov. 9, 2017

(54) METHOD AND APPARATUS FOR A GIMBAL PROPULSION SYSTEM

(71) Applicant: Jody G. Robbins, Phoenix, AZ (US)

(72) Inventor: Jody G. Robbins, Phoenix, AZ (US)

(21) Appl. No.: 15/582,676

(22) Filed: Apr. 29, 2017

Related U.S. Application Data
(60) Provisional application No. 62/331,436, filed on May 4, 2016.

(51) Int. Cl. F03G 3/00

(52) U.S. Cl. CPC F03G 3/00

(57) ABSTRACT

A method and apparatus for a gimbal propulsion system includes at least one pair of gimbals having counter rotating platters and counter rotating spinning weights to produce a net acceleration vector along a desired direction. A second and third pair of gimbals are added having gimbal arms that are spatially offset from each other by 2π/3 radians to produce a smooth acceleration vector along the desired direction.

### FIELD OF THE INVENTION

The present invention generally relates to propulsion systems, and more particularly to gimbal propulsion systems.

### BACKGROUND

Efforts continue to provide effective gimbal propulsion systems.

### SUMMARY

To overcome limitations in the prior art, and to overcome other limitations that will become apparent upon reading and understanding the present specification, various embodiments of the present invention disclose a gimbal array that may be effective to produce linear acceleration having a desired direction and a desired magnitude.

In accordance with one embodiment of the invention, a propulsion device comprises a pair of gimbals configured to produce first and second acceleration vectors. The first and second acceleration vectors combine to produce a net acceleration vector along a desired direction of movement.

In accordance with another embodiment of the invention, a propulsion device comprises a first gimbal having a first arm coupled to a first rotating platter and a second arm coupled to a first spinning weight, where the second arm is raised and lowered through a first pitch cycle and the first platter is rotated through a first rotation cycle. A period of the first pitch cycle and a period of the first rotation cycle are equal. The propulsion device further comprises a second gimbal having a third arm coupled to a second rotating platter and a fourth arm coupled to a second spinning weight, where the fourth arm is raised and lowered through a second pitch cycle and the second platter is rotated through a second rotation cycle. A period of the second pitch cycle and a period of the second rotation cycle are equal.

### BRIEF DESCRIPTION OF THE DRAWINGS

Various aspects and advantages of the invention will become apparent upon review of the following detailed description and upon reference to the drawings in which:

FIG. 1 illustrates an exemplary gimbal in accordance with one embodiment of the invention;

FIG. 2 illustrates an exemplary gimbal in accordance with another embodiment of the invention;

FIG. 3 illustrates an exemplary gimbal in accordance with another embodiment of the invention;

FIG. 4 illustrates an exemplary gimbal pair in accordance with another embodiment of the invention;

FIG. 5 illustrate a system of linear acceleration vectors and their respective net vector sums generated at various positions of the gimbal pair of FIGS. 4; and

FIG. 6 illustrate a system of linear acceleration vectors and their respective net vector sums generated at various positions of a triple gimbal pair in accordance with another embodiment of the invention.

### DETAILED DESCRIPTION

Generally, the various embodiments of the present invention may be applied to generate a linear acceleration vector that may be converted from the gyroscopic precession torque as may be generated from a gimbal-mounted spinning mass. The magnitude and direction of the linear acceleration vector may be controlled along substantially any desired direction of movement. Accordingly, for example, the generated acceleration vector may be used to provide propulsion substantially along any direction with substantially any magnitude.

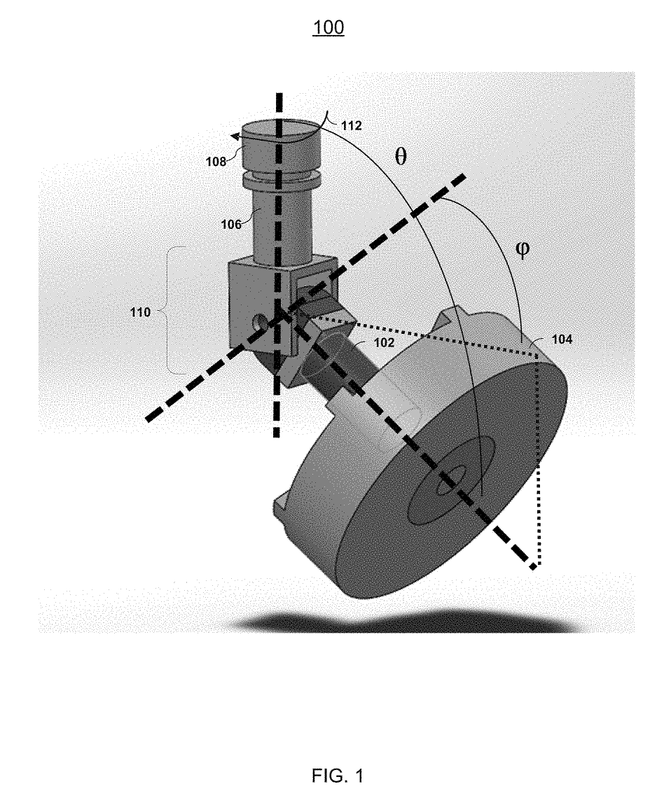

Turning to FIG. 1, gimbal 100 is exemplified whose position may be expressed using the spherical coordinate system. Theta (θ), for example, may be expressed in radians and may give the angle between the lower part of the gimbal arm (e.g., gimbal arm 102 on which spinning weight 104 is mounted) and the upper part of the gimbal arm (e.g., gimbal arm 106 which attaches the assembly to platter 108).

Phi (φ), for example, may be expressed in radians and may give the angle between the orthogonal projection of gimbal arm 102 onto a plane parallel to platter 108 and centered on the joint in the gimbal (e.g., joint 110) and an arbitrary azimuth as further defined below in greater detail.

Radius (r), for example, may be the distance between joint 110 of the gimbal arm and the center of mass of spinning weight 104. As an example, radius (r) may be constant as may be the case when using a fixed length gimbal arm 102.

A spherical expression of the position of gimbal 100 may be expressed as (r, π/2, 0), for example, when gimbal 100 is pointed backward and gimbal arm 102 is raised to 90 degrees. As gimbal arm 102 is lowered from 90 degrees to an angle that is less than 90 degrees (e.g., by k radians) and when gimbal 100 is pointed forward, the spherical expression of the position of gimbal 100 may be expressed as (r, π/2+k, n). Generally, Theta (θ) may be expressed in terms of Phi (φ) as in equation (1):

θ(φ)=(−k/2) cos (φ)+(k+π)/2 (1)

Gimbal 100 may involve a number (e.g., 3) different modes of rotation. A first mode of rotation (e.g., rotation) may refer to the change in position of platter 108 as it rotates (e.g., in direction 112) along angle, Phi (φ), which may be expressed as dcp. A second mode of rotation (e.g., pitch) may, for example, refer to the change in the angle, Theta (θ), as gimbal arm 102 is raised and lowered, which may be expressed as dφ. The third mode of rotation (e.g., spin) may, for example, refer to the rotation of the spinning weight 104 about the axis formed by gimbal arm 102.

As an example, one complete rotation of platter 108 may define an amount of time (e.g., period), which may be described as the amount of time that platter 108 may be rotated through a complete cycle (e.g., 360 degrees or 2π radians). Similarly, an amount of time that the angle through which gimbal arm 102 may be traversed starting from a beginning position (e.g., π/2 radians) to a lower position (e.g., π/2+k radians) and back to its beginning position may be expressed as the same period of time through which platter 108 may be rotated through one complete cycle. Accordingly, for example, as platter 108 completes one rotation cycle, gimbal arm 102 may complete one pitch cycle. Such a synchronized rotation/pitch cycle may be expressed as in equation (2):

dθ/dt=(k/2) sin (φ)(dφ/dt)−(½)(dk/dt) cos (φ)+(½)(dk/dt) (2)

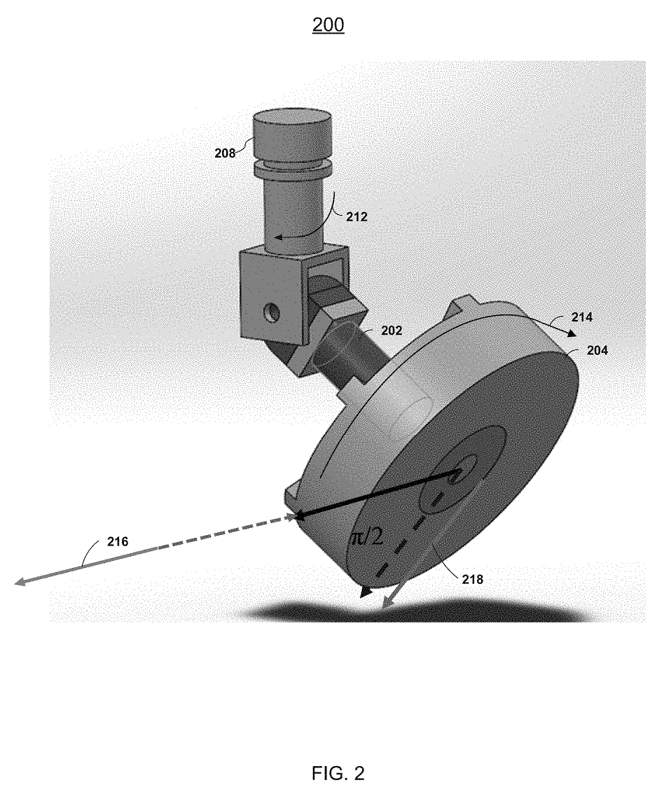

Turning to FIG. 2, a method of propulsion may be explained in terms of rotation and pitch as discussed above in relation to FIG. 1. Platter 208 may, for example, be rotated in direction 212 while spinning weight 204 spins in direction 214. Given the pitch of gimbal arm 102 as shown (e.g., a pitch as defined in its first half period), a torque (e.g., torque 218) may be exerted on gimbal arm 202 which may tend to angle gimbal arm 202 downwards. According to the physical laws that govern gyroscopic movement, the downward tangential acceleration acting on spinning weight 204 may not lower spinning weight 204, but may instead cause spinning weight 204 to precess (e.g., tend to accelerate the rotation of platter 208 in direction 212).

Platter 208, however, may be configured to prevent the precession torque tending to accelerate the rotation of platter 208 along direction 212, and instead may cause spinning weight 204 to drop along torque vector 218. A reactionary acceleration vector 216 may then be produced that may provide the propulsion along a desired direction and magnitude in accordance with one embodiment of the invention.

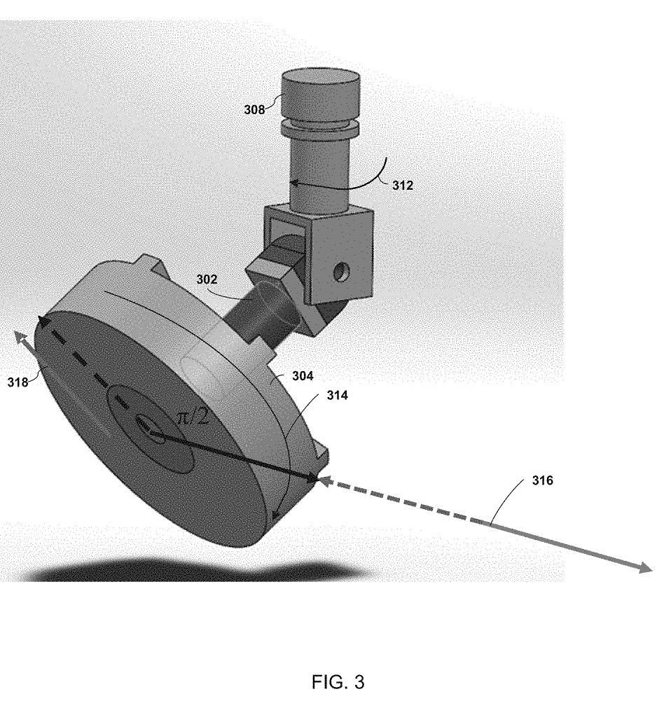

Turning to FIG. 3, the rotation of platter 308 along direction 312 and the spin of spinning weight 304 along direction 314 may remain the same, but the pitch of gimbal arm 302 may be changed (e.g., a pitch as defined in its second half period). Accordingly, a torque (e.g., torque 318) may be exerted on gimbal arm 302 which may tend to angle gimbal arm 302 upwards. According to the physical laws that govern gyroscopic movement, the upward tangential acceleration acting on spinning weight 304 may not raise spinning weight 304, but may instead cause spinning weight 304 to precess (e.g., tend to decelerate the rotation of platter 308 opposite to direction 312).

Platter 308, however, may be configured to prevent the precession torque tending to decelerate the rotation of platter 308 in a direction opposite to 312, and instead may cause spinning weight 304 to raise along torque vector 318. A reactionary acceleration vector 316 may then be produced that may provide the propulsion along a desired direction and magnitude in accordance with one embodiment of the invention.

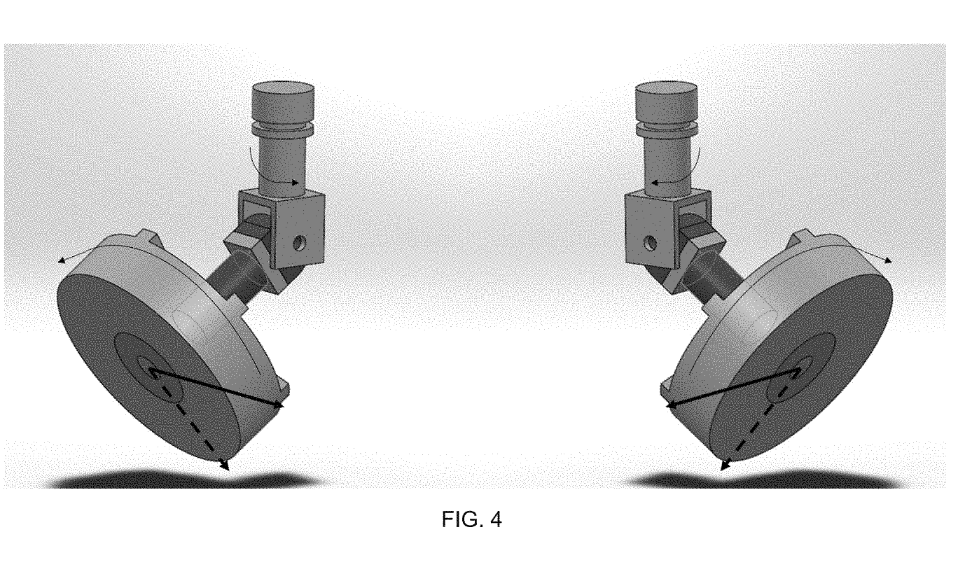

Turning to FIG. 4, a pair of gimbals is exemplified, in which the same rules as discussed above in relation to FIGS. 2 and 3 apply. The rotation of each platter of each gimbal may be in opposite directions and the spin of each spinning weight of each gimbal may be in opposite directions as shown. Accordingly, whenever the direction of a first reactionary acceleration vector is produced by one gimbal that does not coincide with the desired direction of travel, the paired gimbal may produce a second acceleration vector that cancels the first acceleration vector. As a result, the only acceleration vectors produced by the gimbal pair of FIG. 4 are those acceleration vectors produced along a desired direction of travel.

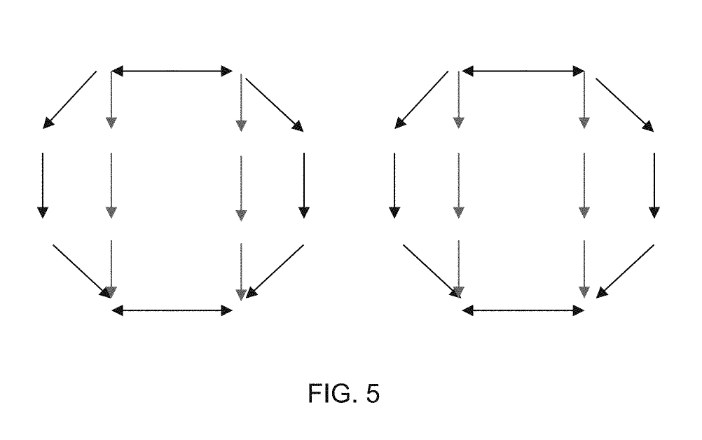

Turning to FIG. 5, a representation of the acceleration vectors produced by each gimbal of the gimbal pair of FIG. 4 at 10 discrete positions of rotation of each respective platter are exemplified (e.g., the acceleration vectors of each gimbal are exemplified in the circular pattern of acceleration vectors of FIG. 5). By counter rotating each respective platter and by counter spinning each respective spinning weight, the respective net acceleration vectors (e.g., the net acceleration vectors are those vectors exemplified as pointing downward) are each pointing in a direction of the intended travel.

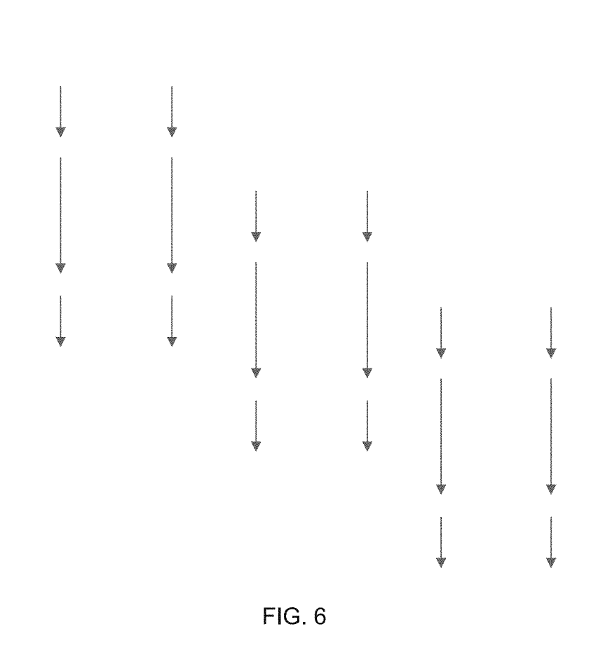

Turning to FIG. 6, a number of pairs (e.g., 3 pair) of gimbals may be utilized to produce the net acceleration vectors as shown. Due to the change of direction, the net forward acceleration may be smaller towards the beginning and end of each period of a pair of gimbals. In one embodiment, in order to provide that the overall motion of the system be smooth, a number of pair (e.g., three pair) of gimbals may be utilized to produce net acceleration vectors in the same direction, but with an offset (e.g., 120 degrees or 2π/3 radians) in the Phi (φ) angle of each gimbal arm of each gimbal pair.

Other aspects and embodiments of the present invention will be apparent to those skilled in the art from consideration of the specification and practice of the invention disclosed herein. It is intended, therefore, that the specification and illustrated embodiments be considered as examples only, with a true scope and spirit of the invention being indicated by the following claims.

What is claimed is:

1. A propulsion device, comprising:
a pair of gimbals configured to produce first and second acceleration vectors, wherein the first and second acceleration vectors combine to produce a first net acceleration vector along a desired direction of movement.

2. The propulsion device of claim 1, further comprising a second pair of gimbals configured to produce third and fourth acceleration vectors, wherein the third and fourth acceleration vectors combine to produce a second net acceleration vector along the desired direction of movement.

3. The propulsion device of claim 2, further comprising a third pair of gimbals configured to produce fifth and sixth acceleration vectors, wherein the fifth and sixth acceleration vectors combine to produce a third net acceleration vector along the desired direction of movement.

4. A propulsion device, comprising:
a first gimbal having a first arm coupled to a first rotating platter and a second arm coupled to a first spinning weight, wherein the second arm is raised and lowered through a first pitch cycle and the first platter is rotated through a first rotation cycle, wherein a period of the first pitch cycle and a period of the first rotation cycle are equal; and
a second gimbal having a third arm coupled to a second rotating platter and a fourth arm coupled to a second spinning weight, wherein the fourth arm is raised and lowered through a second pitch cycle and the second platter is rotated through a second rotation cycle, wherein a period of the second pitch cycle and a period of the second rotation cycle are equal.

5. The propulsion device of claim 4, wherein the first and second rotating platters rotate in opposite directions.

6. The propulsion device of claim 4, wherein the first and second spinning weights spin in opposite directions.

7. The propulsion device of claim 4 further comprising:
a third gimbal having a fifth arm coupled to a third rotating platter and a sixth arm coupled to a third spinning weight, wherein the sixth arm is raised and lowered through a third pitch cycle and the third platter is rotated through a third rotation cycle, wherein a period of the third pitch cycle and a period of the third rotation cycle are equal; and
a fourth gimbal having a seventh arm coupled to a fourth rotating platter and an eighth arm coupled to a fourth spinning weight, wherein the eighth arm is raised and lowered through a fourth pitch cycle and the fourth platter is rotated through a fourth rotation cycle, wherein a period of the fourth pitch cycle and a period of the fourth rotation cycle are equal.

8. The propulsion device of claim 7, wherein the third and fourth rotating platters rotate in opposite directions.

9. The propulsion device of claim 7, wherein the third and fourth spinning weights spin in opposite directions.

10. The propulsion device of claim 7, wherein the first and second pitch cycles are offset in phase with respect to the third and fourth pitch cycles.
